(19) United States
(12) Patent Application Publication
(10) Pub. No.: US 2002/0143517 A1
(43) Pub. Date: Oct. 3, 2002

(54) Logical simulation system, logical simulation method and computer-readable recorded medium

(75) Inventors: Norifumi Kobayashi, Yokohama-Shi (JP); Takayuki Nabeya, Yokohama-Shi (JP)

Correspondence Address: Finnegan, Henderson, Farabow,, Garrett & Dunner, L.L.P., 1300 I Street, N.W., Washington, DC, 20005-3315, US

(73) Assignee: KABUSHIKI KAISHA TOSHIBA

(21) Appl. No.: 10/055,992

(22) Filed: Jan. 28, 2002

(30) Foreign Application Priority Data
Jan. 29, 2001 (JP) 2001-19750

(51) Int. Cl. G06F 17/50

(52) U.S. Cl. 703/19

(57) ABSTRACT

A logical simulation system includes delay information operating part which receives a dispersion rule file in which information on dispersion in a chip having electrical and physical characteristics which influence the operation of an integrated circuit to be analyzed is described and which receives design information of the integrated circuit to prepare a delay information file in consideration of each influence of the information on the dispersion on the basis of the dispersion rule file and the design information; and logical simulation part which receives the design information and the delay information file to carry out a logical simulation of the integrated circuit.

### CROSS REFERENCE TO RELATED APPLICATION

This application claims the benefit of priority from the prior Japanese Patent Application No. 2001-019750, filed on Jan. 29, 2001, the entire contents of which are incorporated herein by reference.

### BACKGROUND OF THE INVENTION

1. Field of The Invention

The present invention generally relates to a logical simulation system, a logical simulation method and a computer-readable recorded medium. More specifically, the invention relates to a logical simulation in a timing verification in a circuit design for a semiconductor integrated circuit (LSI).

2. Description of The Related Art

When a timing verification is carried out by a logical simulation in the development of a semiconductor integrated circuit, there has occurred the following problem. That is, the dispersion in characteristic data relating to timing (a propagation delay time, a setup/hold time, a minimum pulse width, etc.) and the difference in voltage level of a signal are caused by the dispersion in process (the width of a polysilicon, the thickness of an oxide film, a threshold voltage, etc.) caused in a chip, the dispersion in power supply voltage and the dispersion in junction temperature, so that it is insufficient to detect problems in operation by a timing verification which has been conventionally carried out and which is based on a logical simulation taking account of a uniform dispersion coefficient in the chip. In order to solve such a problem, the following three methods have been conventionally mainly used as methods for executing a logical simulation taking account of the above described dispersion in characteristic data relating to timing and of the influences when a power supply are separated, when different processes are mixed and when separated in heat.

The first related art is a method for classifying and preparing a library for a logical simulation system every cell or cell group. This is a method for previously preparing several kinds of libraries for a cell used for a semiconductor integrated circuit being an object to be logical-simulation-verified and for changing a library, which is to be referred, every cell.

However, in this first related method it is required to prepare a plurality of libraries and the number of the kinds of libraries is enormous if it is required to carry out a detailed verification taking account of dispersion. In addition, in order to refer to different libraries with respect to the same cell, it is required to have identification information for each cell. As one method thereof, there is considered a method for pseudo-changing a cell name which is described in a net list of a semiconductor integrated circuit being an object to be logical-simulation-verified. However, in this case, library data for a design environment at a front end and a back end are enormous, so that the management thereof is very complicated. In addition, when it is required to take consideration based on actual layout information of a semiconductor integrated circuit, if any change in circuit and/or layout is carried out, a net list to be logically simulated must be changed on the basis of the change in circuit and layout, so that it is more difficult to manage a data base between the front end and back end.

As the second related art, there is a logical simulation system and logical simulation method taking account of the dispersion in delay time in a data system and a clock system. This is a method by which a logical simulation verification taking account of the dispersion in relative delay can be carried out by extracting a data system path and a clock system path from a net list of a semiconductor integrated circuit, which is an object to be logical-simulation-verified, and by carrying out an operation using different delay coefficients for the respective signal systems.

However, in this second prior art, since delay coefficients independent of each other are set in the data and clock systems, there is a problem in that the timing simulation takes account of impracticable phenomena, so that the redundancy of a timing margin design increases. Also, the actual malfunctions of a semiconductor integrated circuit do not only include malfunctions caused by skews in data and clock systems, but they also include malfunctions caused by hazards caused by mutual skews relating to a plurality of paths between data systems. In the second simulation method, such phenomena can not be verified.

As the third related art, there is a method for verifying a chip or a noticed portion by a circuit simulation using a circuit simulation system taking account of analog characteristics of an SPICE system. In this third prior art, the verification precision is very high and its reliability is high.

However, in the above described third related art, there are following two problems if the scale of a circuit to be verified is large. First, it is difficult to prepare circuit information which is to be inputted to a circuit simulation system. Secondary, it is required to provide a high end environment on which a circuit simulation is carried out. That is, it is required to provide a CPU having a high operation speed and a memory or disk having a large capacity. As a countermeasure thereto, a technique for removing circuit information, which is to be verified, so as not to influence the results of analysis is being developed. However, it is impossible to deny that it takes a lot of time and a great deal of labor until the results of analysis can be acquired.

### SUMMARY OF THE INVENTION

According to a first aspect of the invention, there is provided a logical simulation system comprising: delay information operating part which receives a dispersion rule file in which information on dispersion in a chip having electrical and physical characteristics which influence the operation of an integrated circuit to be analyzed is described and which receives design information of the integrated circuit to prepare a delay information file in consideration of each influence of the information on the dispersion on the basis of the dispersion rule file and the design information; and logical simulation part which receives the design information and the delay information file to carry out a logical simulation of the integrated circuit.

According to a second aspect of the invention, there is provided a logical simulation method comprising: preparing a dispersion rule file in which information on dispersion in a chip having electrical and physical characteristics which influence the operation of an integrated circuit being to be analyzed is described; preparing a delay information file in consideration of each influence of the dispersion on the basis of the dispersion rule file and the design information; and executing a logical simulation of the integrated circuit using the design information and the delay information file.

According to a third aspect of the invention, there is provided a computer-readable recorded medium for use in a computer which receives design information of an integrated circuit to be analyzed to execute a logical simulation of the integrated circuit, the medium having recorded a program for causing the computer to execute a logical simulation method, the method comprising: preparing a dispersion rule file in which information on dispersion in a chip having electrical and physical characteristics which influence the operation of the integrated circuit is described; preparing a delay information file in consideration of each influence of the dispersion on the basis of the dispersion rule file and the design information; and executing a logical simulation of the integrated circuit using the design information and the delay information file.

### BRIEF DESCRIPTION OF THE DRAWINGS

In the accompanying drawings:

FIG. 1 is a block diagram showing an embodiment of a simulation system according to the present invention;

FIG. 2 is a flowchart for explaining a schematic procedure in the first, third and fourth embodiments of a simulation method according to the present invention;

FIG. 3 is a conceptual drawing showing the construction of a chip to be simulated;

FIGS. 4A and 4B are circuit diagrams of two-input NAND circuits to which different power supply voltages are applied;

FIG. 4C is a waveform illustration of the circuit shown in FIG. 4B;

FIG. 5 is a diagram showing an example of a description of a dispersion rule file for use in the logical simulation method shown in FIG. 2;

FIGS. 6 and 7 are flow charts for explaining a schematic procedure in the second embodiment of a logical simulation method according to the present invention;

FIG. 8 is a diagram showing a principal part of an example of a DEF file in a layout data;

FIG. 9A is a circuit diagram of a two-input AND circuit when power supply voltages are different in the same cell;

FIG. 9B is a waveform illustration of the circuit shown in FIG. 9A;

FIG. 10 is a diagram showing an example of a description of a skeleton file for preparing a dispersion rule file for use in the third embodiment of a logical simulation method according to the present invention;

FIG. 11A is a circuit diagram of two-input AND circuits belonging to different groups, in one of which a power supply voltage drops;

FIGS. 11B and 11C are waveform illustrations for explaining a case wherein a delay time must be corrected;

FIG. 12 is a diagram showing an example of a wiring to which the fifth embodiment of a logical simulation method according to the present invention is applied;

FIG. 13 is a diagram showing an example of a skeleton file in a dispersion rule file which is applied to a wiring having the dispersion in temperature; and

FIGS. 14 and 15 are flow charts for explaining a schematic procedure in the fifth embodiment of a logical simulation method according to the present invention.

### DETAILED DESCRIPTION OF THE INVENTION

Referring now to the accompanying drawings, some embodiments of the present invention will be described below.

(1) Preferred Embodiment of Logical Simulation System

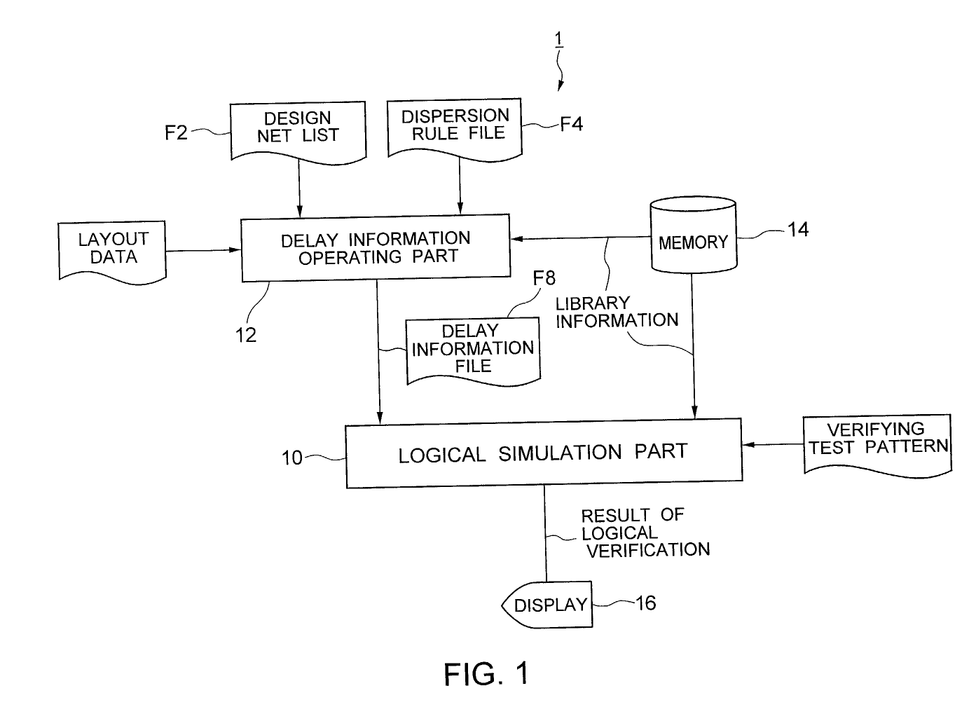

FIG. 1 is a block diagram showing an embodiment of a simulation system according to the present invention. The simulation system 1 shown in this figure comprises a logical simulation part 10, delay information operating part 12 as a feature in this embodiment, a memory 14 and a display 16. FIG. 1 also shows a design net list F2, a dispersion rule file F4, library information, a verifying test pattern and a layout data as required basic input information in the logical simulation system 1, respectively. The memory 14 stores therein library information which will be described later. The memory 14 is connected to the logical simulation part 10 and the delay information operating part 12. The delay information operating part 12 is connected to the logical simulation part 10. The delay information operating part 12 is designed to receive the design net list F2, the dispersion rule file F4 and the library information to prepare a delay information file F8 to supply it to the logical simulation part 10. The delay information operating part 12 constitutes an information classifying unit and a file editing unit as well as a delay information operating unit. As will be described in the second or fifth embodiment of a logical simulation method which will be described later, the delay information operating part 12 can also receive the layout data in addition to the above described three pieces of input information to prepare the delay information file F8. The logical simulation part 10 is designed to receive the delay information file F8, the verifying test pattern information and the library information to execute a logical simulation to output the results of a logical verification. The display 16 is connected to the logical simulation part 19 for displaying the results of the logical verification on a CRT (Cathode Ray Tube) screen.

The design net list F2 is a file group for use in a conventional logical simulation system. For example, the design net list F2 includes a Verilog-HDL format of a gate level in a semiconductor integrated circuit which is an object to be logically simulated.

The library information to be stored in the memory 14 includes various information, such as rule checks and characteristic information relating to each cell and a matrix required for carrying out a logical simulation, e.g., information depending on a process, a provisional wiring model information depending on the matrix of a chip, and an information around a pad depending on a package and so forth.

The verifying test pattern includes an input pattern to a circuit and an expected value pattern of the output thereof which are required for verifying whether a semiconductor integrated circuit to be simulated functions and operates normally in timing without causing any troubles.

The dispersion rule file F4 is a file which is characteristic in this embodiment and in which information for defining dispersion in a chip with electrical and physical characteristics which influence the operation of the semiconductor integrated circuit is described. The above described electrical and physical characteristics include the dispersion in process, such as the width of a polysilicon, the thickness of an oxide film and a threshold voltage, the dispersion in power supply voltage, the dispersion in junction temperature, as well as the separation of a power supply, a mixture of different processes and a thermal separation. Under the influence of these electrical and physical characteristics, problems are caused in the operation of the semiconductor integrated circuit, such as a signal propagation delay, a setup/hold and a deviation in minimum pulse width.

Referring to the operation of the logical simulation system shown in FIG. 1, the embodiments of a logical simulation method according to the present invention will be described below.

(2) First Embodiment of Logical Simulation Method

Referring to FIGS. 1 through 5, the first embodiment of a logical simulation method according to the present invention will be described below.

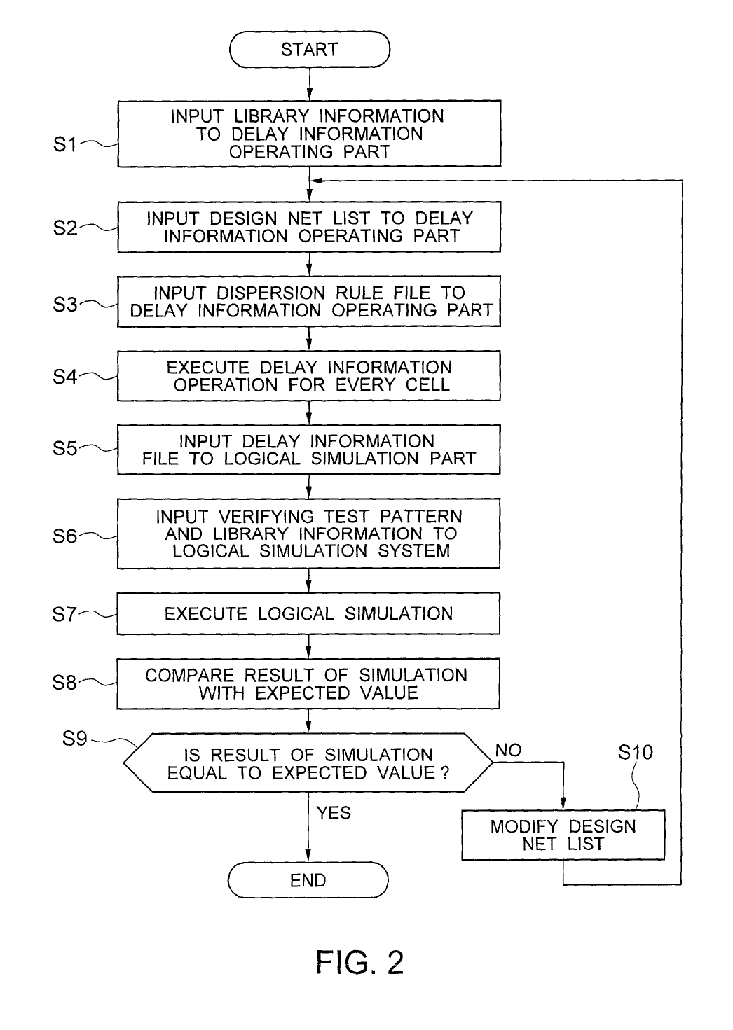

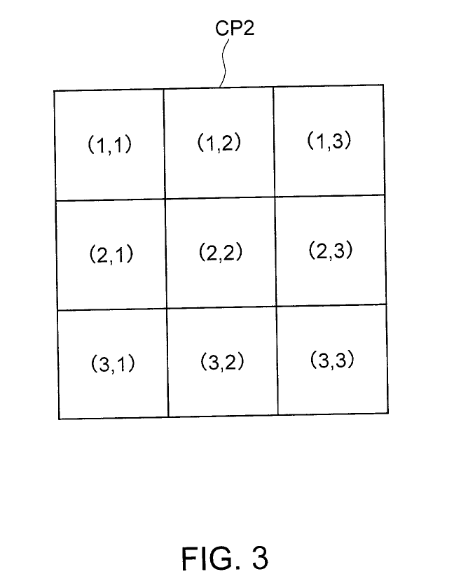

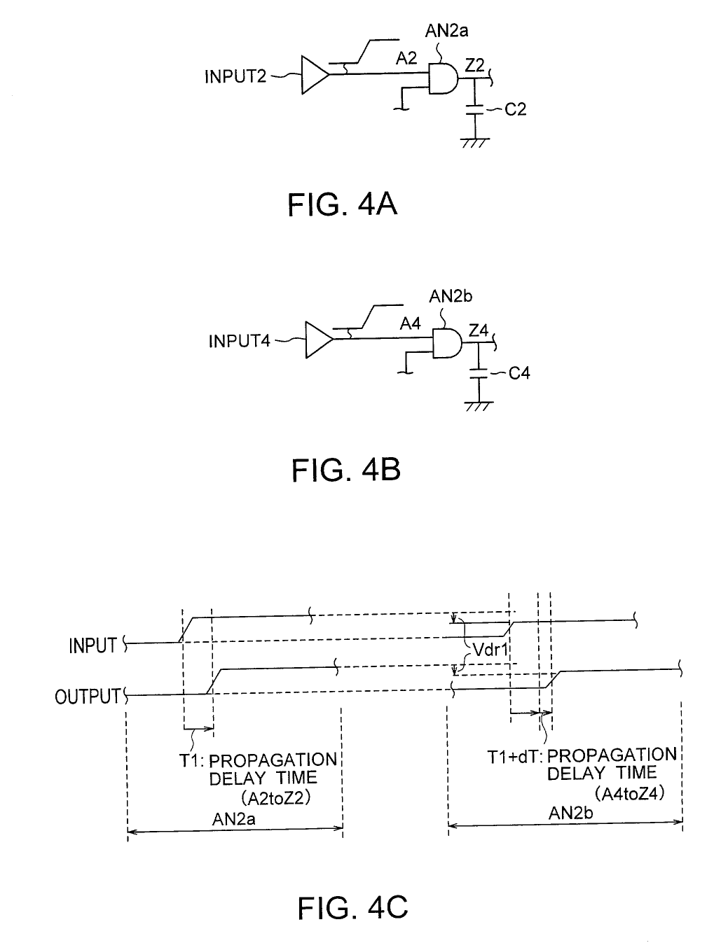

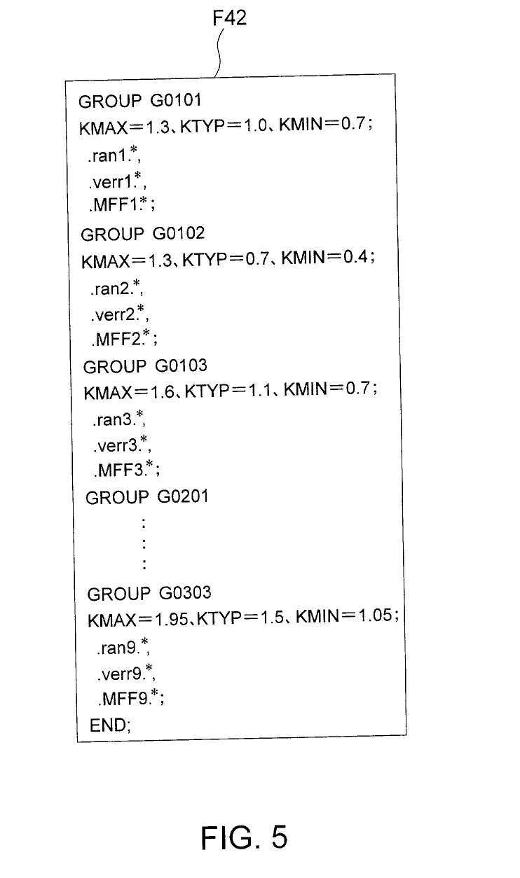

FIG. 2 is a flowchart for explaining a schematic procedure in a logical simulation method in this embodiment. FIG. 3 is a conceptual drawing showing the construction of a chip which is an object to be simulated. FIG. 4A and FIG. 4B are circuit diagrams and FIG. 4C is a waveform illustration, each of FIGS. 4A through 4C explains malfunction caused when power supply voltages are different in the chip shown in FIG. 3. FIG. 5 shows an example of a description of a dispersion rule file F4 for use in a logical simulation method in this embodiment.

As shown in FIG. 2, first, the library information, the design net list F2 and the dispersion rule file F4 are inputted to the delay information operating part 12 (steps S1 through S3). Then, the delay information operating part 12 executes a delay information operation for every cell which is described in the design net list F4 on the basis of the inputted information (step S4) and prepares a delay information file (which is generally an SDF file) F8 to supply the prepared file to the logical simulation part 10 (step S5).

Referring to FIGS. 3 through 5, a method for preparing a delay information file (SDF file) F8 will be described below in detail.

For example, even in a two-input AND gate having the same specification (which will be hereinafter referred to as AN2), if a chip is considered to be divided into 3×3 regions like a chip CP2 shown in FIG. 3, there are some cases where power supply voltages to be applied are different in the AN2s which are arranged in each region.

This state is shown in FIGS. 4A and 4B. FIGS. 4A and 4B show AN2a and AN2b which are included in regions (1, 1) and (3, 3) of the chip CP2 shown in FIG. 3, respectively. In the AN2a and AN2b , outputs Z2 and Z4 are connected to a circuit (not shown) and grounded via capacitors C2 and C4, respectively. FIG. 4C shows a waveform of signals which are inputted to terminals A2 and A4 from INPUTs 2 and 4 of two input terminals of the AN2a and AN2b, respectively, and a waveform of signals which are outputted from the output terminals Z2 and Z4, respectively. The left part of the waveform in FIG. 4C shows that the power supply voltage is ideal in the region (1, 1). On the other hand, the right part of the waveform in FIG. 4C shows that the power supply voltage drops in the region (3, 3). In such a case, since the power supply voltage drops by Vdr1 in the AN2b which is arranged in the region (3, 3), a propagation delay time (A4 to Z4) is longer by dT than a propagation delay time (A2 to Z2) T1 in the AN2a which is arranged in the region (1, 1).

In such a case, the delay information operating part 12 calculates a corrected value of a propagation delay time from an input terminal A2 to an output terminal Z2 in the region (1, 1) on the basis of a waveform through rate which is inputted to the terminal A2, a load capacity C2 which is connected to the output terminal Z2, and a delay time information data relating to a numerical point which uses, as parameters, a through rate and a load capacity in library information stored in the memory 14.

If an identification cell instance of the AN2a arranged in the region (1, 1) is defined as “U0101”, an example of a description of an SDF file is as follows.

(CELL (CELLTYPE “AN2”) (INSTANCE U0101)
(DELAY

(ABSOLUTE

(IOPATH B Z (0.15 : 0.21 : 0.27) (0.12 : 0.17 : 0.22)
(IOPATH A Z (0.21 : 0.30 : 0.39) (0.13 : 0.18 : 0.23))

)

)
)

Similarly, if an identification cell instance of the AN2b arranged in the region (3, 3) is defined as “U0303”, an example of a description of an SDF file is as follows. This is obtained by multiplying the above described delay information of the AN2a, which is arranged in the region (1, 1) by a delay coefficient 1.5 in consideration of the increase of a delayed quantity corresponding to Vdr1 being a power supply voltage drop, in accordance with an example of a description of a dispersion rule file F4 which is shown in FIG. 5 and which will be described later.

(CELL (CELLTYPE “AN2”) (INSTANCE U0303)
(DELAY

(ABSOLUTE

(IOPATH B Z (0.22 : 0.32 : 0.41) (0.18 : 0.26 : 0.33))
(IOPATH A Z (0.32 : 0.45 : 0.59) (0.19 : 0.27 : 0.35))

)

)
)

The delay information calculated by the delay information calculating part 12 is thus obtained by correcting the delay coefficient on the basis of information on the dispersion rule file F4 with respect to each cell.

The above described operation can also be carried out with respect to the delay information file (SDF) which is obtained after a usual delay operation is carried out.

However, in this embodiment, since the dispersion rule file F4 is taken into account in the delay information operation which is carried out by the delay information operating part 12, it is possible to previously take account of a delay coefficient when an input waveform through rate is calculated, so that it is also possible to take account of a phenomenon that the waveform is dulled by the power supply drop. Thus, it is possible to more precisely calculate the delay.

The dispersion rule file F4 will be described below in more detail.

In the example of the chip CP2 shown in FIG. 3, the chip CP2 is divided into 3×3=9 regions. The instances of all the cells which are included in the design net list F2 are divided into groups and described in the dispersion rule file F4 so as to correspond one to one each other in accordance with the regions thus divided.

FIG. 5 shows an example of a dispersion rule file F4 thus described. In the dispersion rule file F42 shown in this figure a unique name of each group, a delay coefficient definition to the group and the instances of cells included in the group are described. In this embodiment the delay coefficient is defined as KMAX/KTYP/KMIN. However, the number and form of the definitions can optionally be determined. In fact, there may be used a method for inputting a switch parameter capable of identifying which file in the dispersion rule file F4 should be used by the delay coefficient which is used when the delay information operation (step S4) is executed.

Furthermore, in FIG. 5, the instances of the cells included in each group are shown by a normalized expression for simple explanation.

Moreover, the concrete description of the dispersion rule file F4 should not be limited to the method for apparently defining the dispersion rule file F4 as a delay coefficient for each group. Coefficients for process, power voltage or temperature may be independently defined to be processed by the delay information operation (step S4).

Referring to FIG. 2 again, the delay information file (SDF) obtained by the above described method is supplied to the logical simulation part 10 (step S5). The logical simulation part 10 incorporates a verifying test pattern and library information which is stored in the memory 14 (step S6), executes a logical simulation (step S7) and compares the result of the simulation with an expected value in the verifying test pattern (step S8) to cause the display part 16 to display the result of comparison thereon. If the result of the simulation is coincident with the expected value (step S9), the logical simulation is completed. If the result of the simulation is not coincident with the expected value (step S9), the design net list F2 is modified (step S10), and the above described series of steps are repeated (steps S2 through S9). Specifically, the modification of the design net list F2 is carried out by the modification of the circuit layout and the revision of the power supply method, and by a redesign if the detected operational malfunction is significant.

Thus, according to this embodiment, since the dispersion in the chip with electrical and physical characteristics which influence the operation of the semiconductor integrated circuit is considered, it is possible to carry out a logical simulation with a simple construction with a high verification precision and at a high verification speed. Thus, since it is possible to find problems prior to the evaluation of an actual chip, it is possible to greatly shorten the time required to develop a semiconductor integrated circuit.

(3) Second Preferred Embodiment of Logical Simulation Method

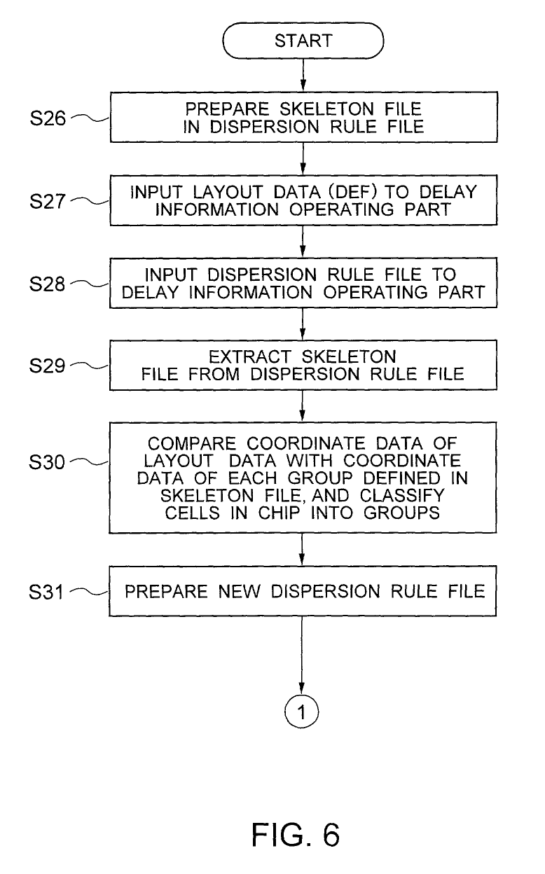

Referring to FIGS. 6 through 8, the second embodiment of a logical simulation method according to the present invention will be described below. This embodiment is characterized in that a dispersion rule file F4 is prepared on the basis of the actual configuration coordinates of each cell in a layout data (e.g., DEF) for a chip.

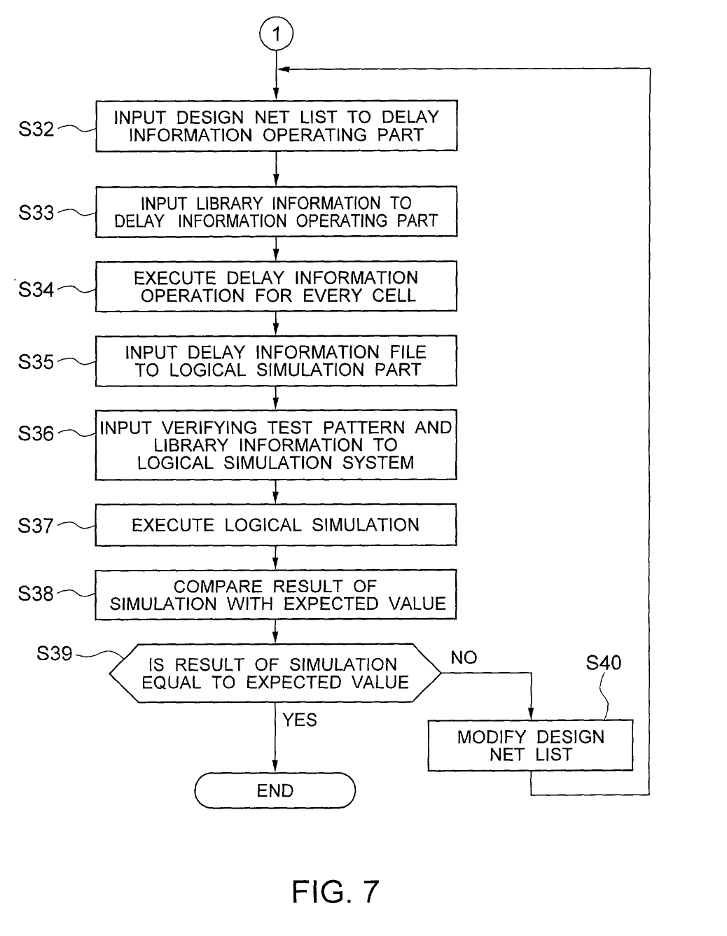

FIGS. 6 and 7 are flow charts for explaining a schematic procedure of a logical simulation method in this embodiment.

First, as shown in FIG. 6, a skeleton file in which coordinates of each group and a delay coefficient in the group are defined is previously prepared in the dispersion rule file F4 (step S26). Then, the layout data (DEF) and the dispersion rule file F4 which includes the above described skeleton file are inputted to the delay information operating part 12 (steps S27 and S28).

In the layout file (DEF), the instance of the cell after layout, the kind, arrangement method and configuration coordinates of the cell and the directions of the arranged cell are described. An example thereof is shown below.

U47AN2+PLACED (150 150) N;

U48EN+PLACED (250 150) FS;

U49EN+PLACED (350 150) FS;

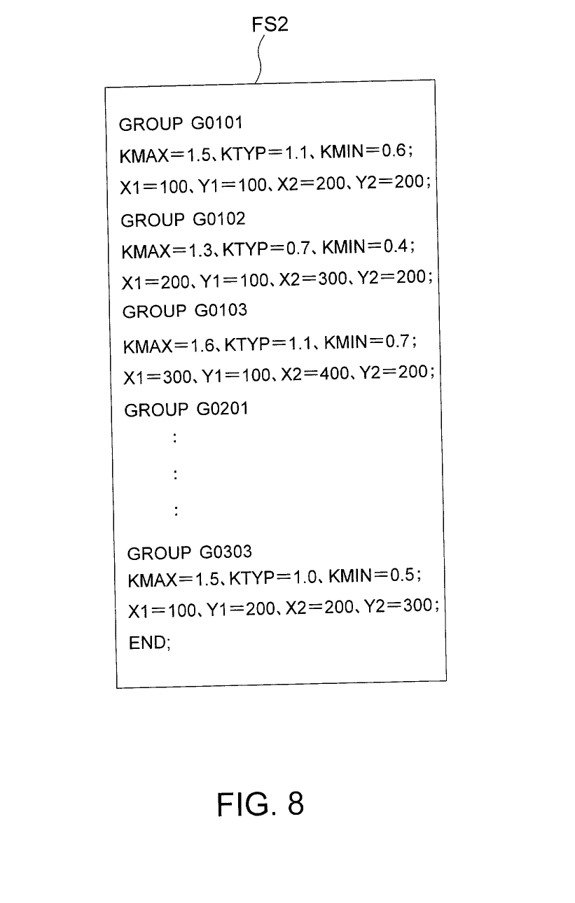

FIG. 8 shows a principal part of an example of a DEF file in a layout data. For example, in the DEF file FS2 shown in this figure, the coordinates of Group G0101 are defined as X1=100, Y1=100, X2=200 and Y2=200, and the coordinates of Group G0102 are defined as X1=200, Y1=100, X2=300 and Y2=200.

Then, referring to FIG. 6 again, the delay information operating part 12 extracts such a skeleton file from the dispersion rule file F4 (step S29), compares the coordinate data with coordinate data defined in the DEF with respect to all of cells which are to be verified, and classifies which group of the skeleton file the coordinate data for each cell belongs to (step S30). As the results of processing in the above described example, U47 is classified in Group G0101, U48 is classified in Group G0102 and U49 is classified in Group G103.

Then, the delay information operating part 12 prepares a new dispersion rule file F4′ including the results of the classification (step S31).

Moreover, as shown in FIG. 7, the delay information operating part 12 carries out a timing verification on the basis of the new dispersion rule file, which is obtained by the above described procedure, by the same procedure as the logical simulation method which is described in the first embodiment (steps S32 through S40). The explanation of the procedure shown in FIG. 7 is omitted since the procedures in the steps S32 through S40 are substantially the same as those in the steps S2 through S10 of the procedure shown in FIG. 2 and 30 is simply added to each step number.

(4) Third Preferred Embodiment of Logi0cal Simulation Method

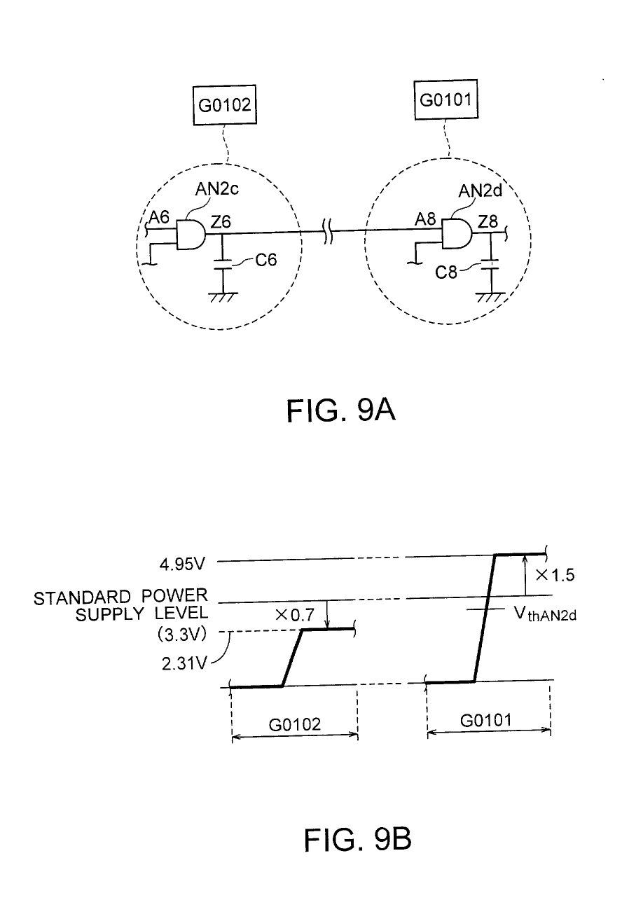

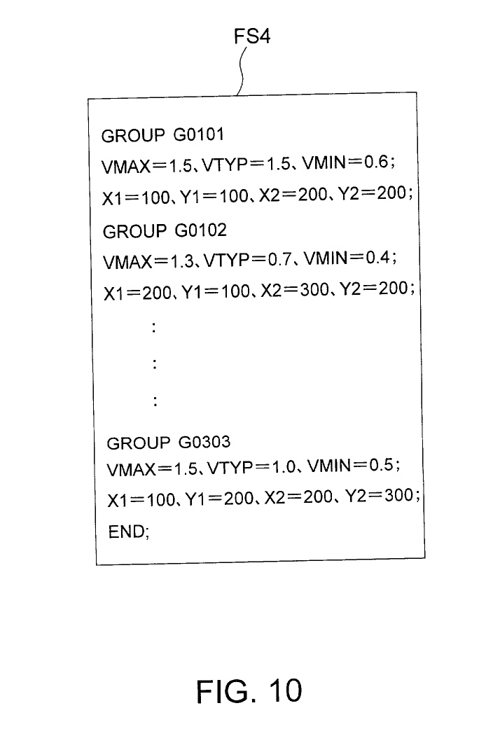

Referring to FIGS. 9A through 10, the third embodiment of a logical simulation method according to the present invention will be described below. This embodiment is applied to a case where power supply voltages are different in the respective cells of the same chip. Such a phenomenon particularly considerably appears when the construction of a chip from which a power supply is separated is adopted.

FIGS. 9A and 9B are illustrations for explaining operational problems in such a phenomenon. FIG. 9A is a circuit diagram of an AN2c belonging to a group G0102 on the signal transmitting side and of an AN2d belonging to a group G010 on the signal receiving side and FIG. 9B is a waveform illustration showing a voltage level of a signal in each group.

The AN2c and AN2d shown in FIG. 9A are two-input AND circuits which are formed in different cells in the same chip and which are connected to each other directly or via another element. The output terminal Z6 of the AN2c is grounded via a capacitor C6 and is connected to the input terminal A8 of the AN2d. The AN2c is on the signal transmitting side, and the AN2d is on the signal receiving side. In addition, the output terminal Z8 of the AN2d is also grounded via a capacitor C8.

When the power supply voltage on the signal transmitting side AN2c is different from the power supply voltage on the signal receiving side AN2d, operational problems might be caused in an actual circuit, so that there is some possibility that the transmission of signals is not normally carried out. In such cases, the logical simulation part 10 of the logical simulation system 1 shown in FIG. 1 has the function of receiving information of the dispersion rule file F4 via the delay information operating part 12 to carry out a rule check on the basis of this information. This can be carried out by causing the dispersion rule file F4 to include a dispersion data relating to the power supply voltage and by ascertaining a voltage level of an output signal for each cell.

The procedures of the logical simulation method in this embodiment are in themselves substantially the same as the procedures shown in the flow chart of FIG. 2. Specifically, the logical simulation part 10 executes a rule check in the procedures of steps S7 through S9 of FIG. 2 by preparing a skeleton file, which defines a coefficient of a power supply voltage for every group, in the dispersion rule file F4.

FIG. 10 shows an example of a description of a skeleton file for preparing such a dispersion rule file F4. In the example shown in this figure, in a group G0102 a power supply voltage has a coefficient of 0.7 on a Typical condition (VTYP=0.7), and in a group G0101 a power supply voltage has a coefficient of 1.5 on a Typical condition (VTYP=1.5).

Therefore, as shown in FIG. 9B, the output voltage of the group G0101 is 3.3 (V)×1.5=4.95 (V), and on the other hand, the output voltage of the group S0102 is 3.3 (V)×0.7=2.31 (V). In such a case, the output voltage of the AN2c of the group G0102 can not exceed the threshold voltage V_{thAN2d} of the AN2d of the group G0101, so that it is not possible to precisely transmit signals.

According to this embodiment, since it is possible to find such a problem caused by the fact that the power supply voltage is different for each cell, it is possible to previously eliminate the problem prior to the evaluation of an actual chip by the modification and redesign of the circuit layout and the revision of the power supply method or the like.

In addition, it is possible to suitably determine the described reference of decision whether a normal operation can be logically carried out.

(5) Fourth Preferred Embodiment of Logical Simulation Method

The fourth embodiment of a logical simulation method according to the present invention will be described below. The method in this embodiment is applied to a case where some correction of a delay time is required although the voltage level of the signal is not a level at which the normal operation can not be insured after the voltage level of the signal is checked by the logical simulation in the above described third embodiment. Therefore, the procedures of the logical simulation method in this embodiment are in themselves also substantially the same as the procedures shown in the flow chart of FIG. 2, but the concrete contents of the delay information operation (step 4) are different from those in the above described second embodiment.

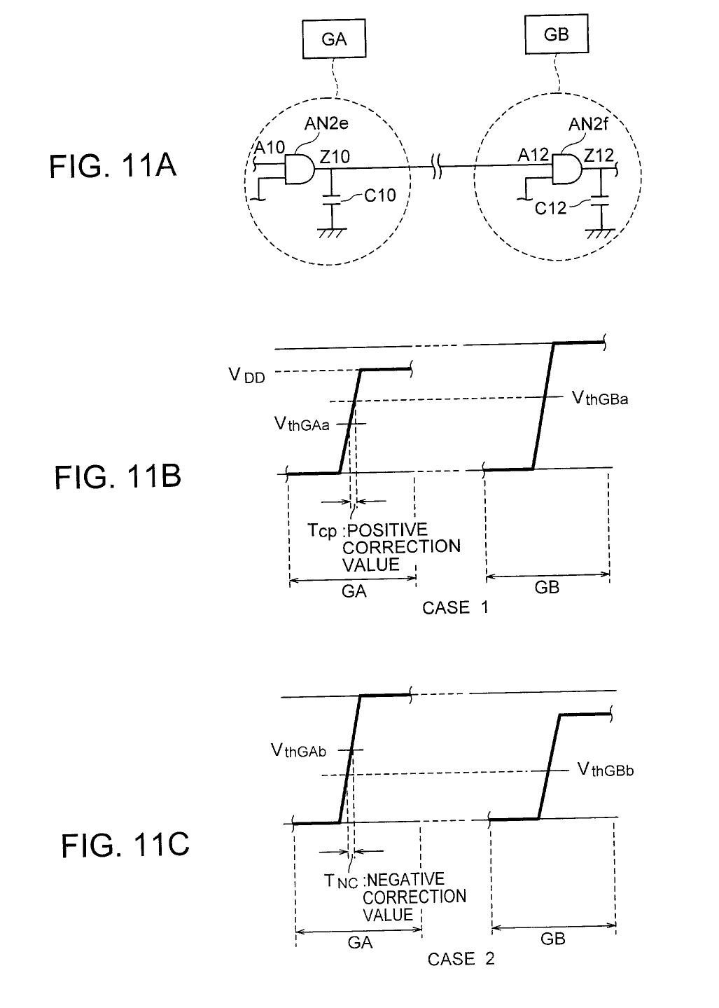

Referring to FIGS. 11A through 11C, a concrete example when the correction of a delay time according to this embodiment is required will be described below. FIG. 11A is a circuit diagram of an AN2 belonging to different groups in which a power supply voltage drops in any one of the groups, and FIGS. 11B and 11C are waveform illustrations for explaining two cases wherein the correction of a delay time is required.

FIG. 11A shows an AN2e belonging to a group GA and an AN2f belonging to a group GB. The output terminal Z10 of the AN2e of the group GA is connected to the input terminal A12 of the AN2f of the group GB directly or indirectly via another element. Furthermore, the output terminals Z10 and Z12 of the AN2e and AN2f are grounded via capacitors C10 and C12, respectively.

FIG. 11B shows a case (case 1) where the power supply voltage in the group GA drops and the power supply voltage in the group GB rises. In this case, the difference between the power supply voltages of the two groups is relatively equivalent to a case where GA<GB.

In the logical simulation system 1 shown in FIG. 1, the delay information file F8 (SDF) which is operated by the delay information operating part 12 to be inputted to the logical simulation part 10 includes delay time information which is determined at an intermediate level of the power supply voltage V_{DD} shown in FIG. 11B. However, if an actual delay time in the AN2f of the group GB is considered, the delay time of the AN2e belonging to the group GA is defined at the intermediate level of the power supply voltage V_{DD} in the group GA, so that the level of the output signal of the AN2e does not reach the threshold voltage V_{thGBa}, which is supposed in the group GB, when the level of the output signal of the AN2e reaches the threshold voltage V_{thGAa}. Therefore, it is required to correct such a delay time (T_{CP}) in the case 1 using some method. Three methods considered as the correcting methods include a method (a first correcting method) for adding as a delay time of the AN2e of the group GA, a method (a second correcting method) for adding as a delay time of the AN2f of the group GB and a method (a third correcting method) for adding as a wiring delay.

In the first method, i.e., in the method for adding as a delay time of the AN2e of the group GA, there are considered a case where the output of the AN2e is also connected to another AN2 of the same group GA and a case where the output of the AN2e is connected to a group other than the groups GA and GB. In these cases, the correction is very complicated. If it is defined in PORT of the delay information file (SDF) as a wiring delay by the third method, it is very difficult to carry out a definition wherein a leading edge is distinguished from a trailing edge, or there are some cases where it is impossible to carry out such a definition. Therefore, the second method for adding as a delay time of the AN2f of the group GB is preferred. In the case 1 of FIG. 11B, the delay information operating part 12 executes a processing for adding a time after the voltage level of the output signal of the AN2e of the group GA reaches the threshold level V_{thGAa} defined in the group GA and until it reaches the threshold level V_{thGBa} defined in the group GB, to the AN2f of the group GB as a “positive correction value T_{CP}” and supplies it to the logical simulation part 10 as a new delay information file (SDF) F8′.

On the other hand, in the case 2 shown in FIG. 11C, the power supply voltage in the Group GB drops and the power supply voltage in the group GA rises. As shown in this figure, in the case 2 the delay information operating part 12 executes an operation for subtracting a time after the output signal level of the AN2e of the group GA reaches the threshold level V_{thGBb} defined in the group GB and until the output signal level reaches the threshold level V_{thGAb} defined in the group GA, from the AN2f of the group GB as a “negative correction value T_{CD}”, and supplies it to the logical simulation part 10 as a new delay information file (SDF) F8″.

While the delay time in the leading edge of the signal waveform has been shown in the cases shown in FIGS. 11A through 11C, the correction of timing can be carried out by applying the logical simulation method in this embodiment to a trailing edge of the signal waveform. In the above described embodiment, the case where the logical value “0” level is the same and only the level of the logical value “1” is different has been described. However, the method in this embodiment can also be used for correcting timing in a case where the level of the logical value “1” is the same and only the level of the logical value “0” is different and in a case where both of the levels of the logical values “0” and “1” are different.

(6) Fifth Preferred Embodiment of Logical Simulation Method

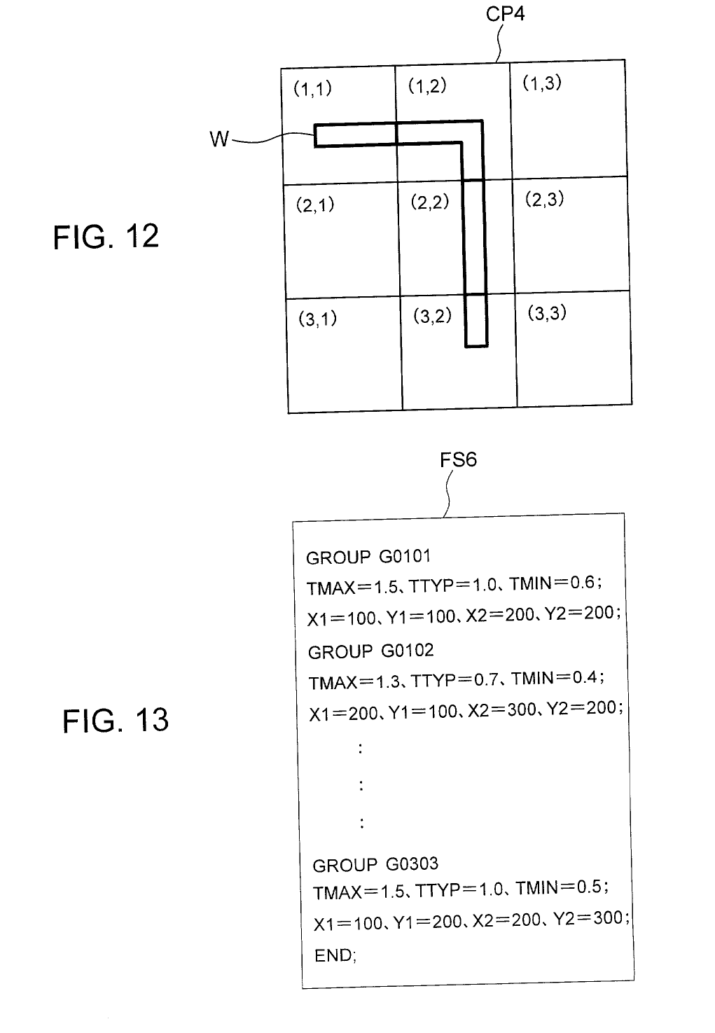

Referring to FIGS. 12 through 15, the fifth embodiment of a logical simulation method according to the present invention will be described below. In this embodiment, there is provided a logical simulation method which is preferably used when the temperature of a wiring in a chip is uneven.

FIG. 12 shows an example of a wiring to which the logical simulation method in this embodiment is applied. The wiring W shown in this figure is formed so as to extend over a plurality of regions divided in a chip CP4 and is characterized in that the temperature of wiring in each region is different. The wiring W is formed so as to pass through four regions, for example in order of region (1, 1) region (1, 2) region (2, 2) region (3, 2).

FIG. 13 shows an example of a skeleton file in the dispersion rule file F4 which is applied to a wiring having such dispersion in temperature. In the skeleton file FS6 shown in this figure, a coefficient relating to temperature on a Typical condition in the region (1, 1), i.e., in the Group G0101, is “1” with respect to the default value of a library used in a logical simulator (TTYP=1.0). On the Max condition the coefficient is “1.5” (TMAX=1.5). When the default value is 25° C., 25×1.5=37.5° C.

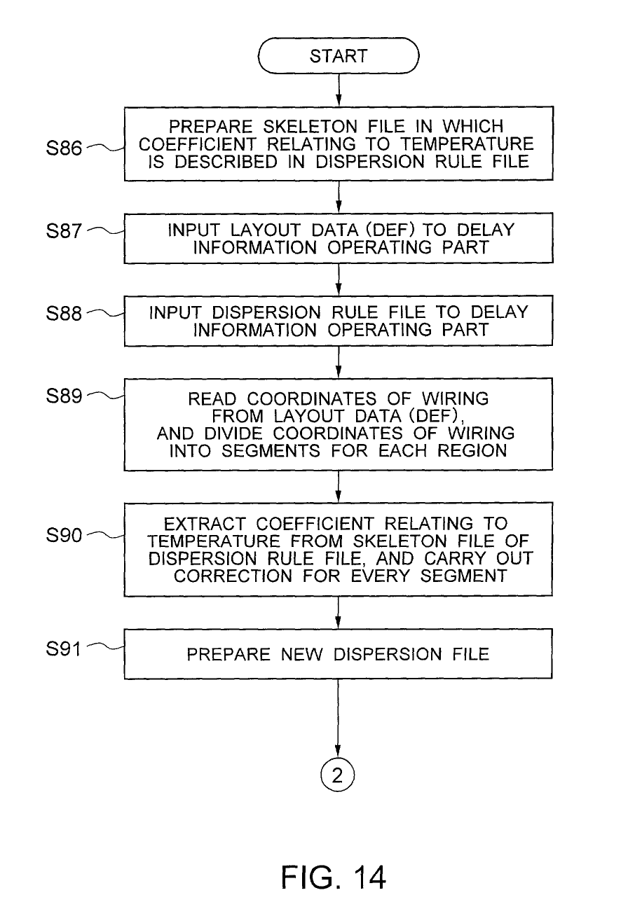

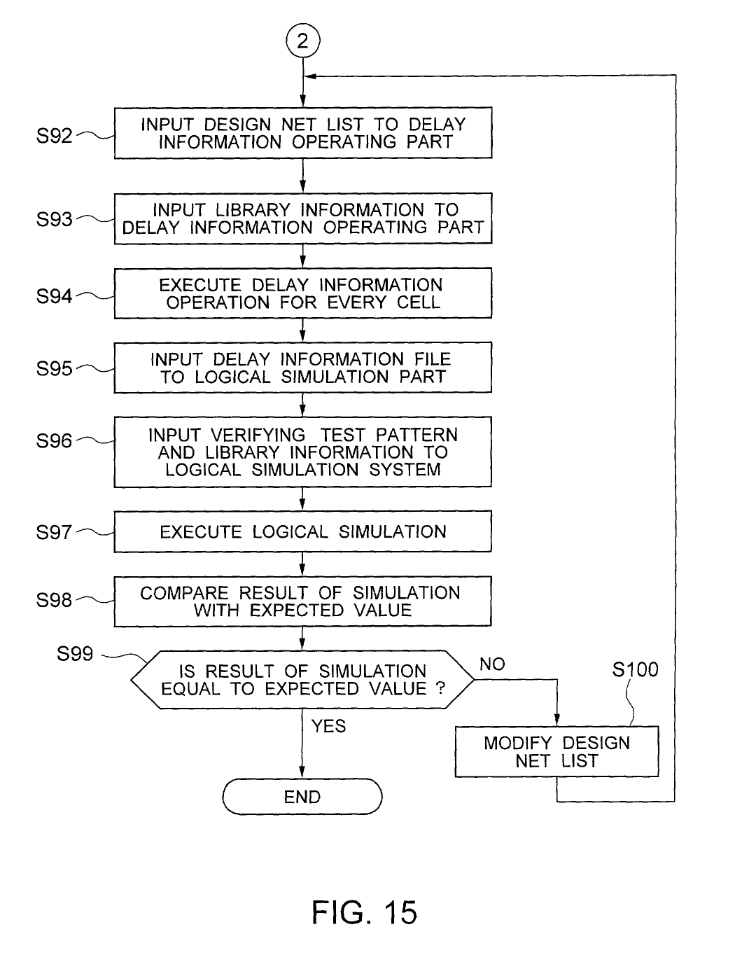

FIGS. 14 and 15 are flow charts for explaining the schematic procedures of the logical simulation method in this embodiment. The flow chart shown in FIG. 15 is substantially the same as the flow chart shown in FIG. 2 except that 90 is added to each step number of the steps S2 through S10 of the flow chart of FIG. 2, so that the procedures shown in FIG. 14 will be mainly described below.

First, a skeleton file in which a coefficient relating to temperature is described, such as a skeleton file FS6 shown in FIG. 13, is previously prepared in the dispersion rule file F4 (step S86), and the layout data (e.g., DEF) and the dispersion rule file F4 are inputted to the delay information operating part 12 (steps S87 and S88).

Then, the coordinates of the wiring are read out of the layout data (DEF) to divide the coordinates into segments for each region(step S89).

Thereafter, a coefficient relating to temperature is read out of the skeleton file of the dispersion rule file F4, and this coefficient is utilized for correcting each segment (step S90) to prepare a new dispersion rule file F4″.

Thereafter, as shown in FIG. 15, a logical simulation is carried out by procedures which are substantially the same as those explained in the logical simulation method in the first embodiment (step S92 through S100).

As specific corrections at step S90, the following methods are considered to be suitably used. That is, there are a method for processing a library value when a delay time is calculated and a method for processing a resistance value of each segment, as well as a method for processing the shape (e.g., width) of a wiring when a constant value is always used as a resistance value in a verification environment.

According to this embodiment, it is possible to carry out a precise verification by carrying out a timing verification with a logical simulator using the wiring delay value thus calculated as delay information.

(7) Recorded Medium

While the logical simulation methods in the above described five embodiments have been described as the operations of the logical simulation system shown in FIG. 1, the series of procedures described in these embodiments are never procedures capable of being executed only a dedicated purpose machine. The logical simulation methods may be stored in a recorded medium, such as a floppy disk or a CD-ROM, in the form of a program which is to be executed by a general purpose computer and may be read by the computer to be executed. Thus, a logical simulation method according to the present invention can be realized by using an external server or a stand-alone general purpose computer. The recorded medium should not be limited to a portable recorded medium, such as a magnetic disk or an optical disk, and may be a fixed type recorded medium, such as a hard disk drive or a memory. A program including the above described series of procedures in the logical simulation method may be distributed via a communication line (including a radio communication), such as Internet. Moreover, the program including the above described series of procedures in the logical simulation method may be enciphered, modulated or compressed to be distributed via a wire or radio line, such as Internet, or to be stored in a recorded medium to be distributed.

While some embodiments of the present invention have been described, it can be clearly seen by persons with ordinary skill in the art that the present invention should not be limited to the above described embodiments, but the invention can be modified and carried out in various ways without departing from the scope and spirit of the invention. While the logical simulation using the test pattern has been described in the above described embodiments, the present invention should not be limited thereto. For example, of course, the present invention can be applied to a “static timing analysis” technique for carrying out a delay time analysis of a specified route only by design information and delay information without the need of any test patterns.

What is claimed is:

1. A logical simulation system comprising:
delay information operating part which receives a dispersion rule file in which information on dispersion in a chip having electrical and physical characteristics which influence the operation of an integrated circuit to be analyzed is described and which receives design information of the integrated circuit to prepare a delay information file in consideration of each influence of said information on said dispersion on the basis of said dispersion rule file and said design information; and
logical simulation part which receives said design information and said delay information file to carry out a logical simulation of the integrated circuit.

2. A logical simulation system as set forth in claim 1, wherein said delay information operating part corrects said design information on the basis of said dispersion, and
said delay information file includes the corrected design information.

3. A logical simulation system as set fourth in claim 1, which further comprises an information classifying unit which classifies said information on said dispersion into groups of an optional size, said groups constituting said chip, and
wherein said delay information file is prepared so that the influence of said dispersion is considered for every said group.

4. A logical simulation system as set forth in claim 1, wherein said design information includes actual configuration information which is information on the position of a cell of the integrated circuit in an actual configuration, and
said logical simulation system further comprises a file editing unit which receives said dispersion rule file to cause said information on said dispersion to correspond to said actual configuration information to edit said dispersion rule file.

5. A logical simulation system as set forth in claim 1, wherein said electrical and physical characteristics include a power supply voltage, and
said logical simulation includes verification whether abnormality is caused in the transmission of said signal by the difference in said power supply voltage in the same chip.

6. A logical simulation system as set forth in claim 2, wherein said electrical and physical characteristics include a power supply voltage, and
said delay information operating unit calculates dispersion of signal level caused by dispersion in said power supply voltage, and a delay time of signal transmission caused by the dispersion of the signal level.

7. A logical simulation system as set forth in claim 1, wherein said design information includes information on wiring,
said delay information operating unit divides said information on wiring into segments corresponding to said size of said group, and
said delay information file is prepared so that the influence of said dispersion is considered for every said segment.

8. A logical simulation method comprising:
preparing a dispersion rule file in which information on dispersion in a chip having electrical and physical characteristics which influence the operation of an integrated circuit being to be analyzed is described;
preparing a delay information file in consideration of each influence of said dispersion on the basis of said dispersion rule file and said design information; and
executing a logical simulation of the integrated circuit using said design information and said delay information file.

9. A logical simulation method as set forth in claim 8, which further comprises correcting said design information on the basis of said dispersion, and
wherein said delay information file includes the corrected design information.

10. A logical simulation method as set fourth in claim 8, which further comprises classifying said information on said dispersion into groups of an optional size, said groups constituting said chip, and
wherein said delay information file is prepared so that the influence of said dispersion is considered for every said group.

11. A logical simulation method as set forth in claim 8, wherein said design information includes actual configuration information on the position of a cell of the integrated circuit in an actual configuration, and
said logical simulation method further comprises causing said information on said dispersion to correspond to said actual configuration information to edit said dispersion rule file.

12. A logical simulation method as set forth in claim 8, wherein said electrical and physical characteristics include a power supply voltage, and
said executing of said logical simulation includes verifying whether abnormality is caused in the transmission of said signal by the difference in said power supply voltage in the same chip.

13. A logical simulation method as set forth in claim 8, wherein said electrical and physical characteristics include a power supply voltage, and
said executing of said logical simulation further comprises calculating dispersion of signal level caused by dispersion in said power supply voltage, and a delay time of signal transmission caused by the dispersion of signal level.

14. A logical simulation method as set forth in claim 10, wherein said design information includes information on wiring,
said logical simulation method further comprises dividing said information on wiring into segments corresponding to said size of said group, and
said delay information file is prepared so that the influence of said dispersion is considered for every said segment.

15. A computer-readable recorded medium for use in a computer which receives design information of an integrated circuit to be analyzed to execute a logical simulation of the integrated circuit, said medium having recorded a program for causing said computer to execute a logical simulation method, said method 8 comprising:
preparing a dispersion rule file in which information on dispersion in a chip having electrical and physical characteristics which influence the operation of the integrated circuit is described;
preparing a delay information file in consideration of each influence of said dispersion on the basis of said dispersion rule file and said design information; and
executing a logical simulation of the integrated circuit using said design information and said delay information file.

16. A computer readable recorded medium according to claim 15, wherein said logical simulation method further comprises correcting said design information on the basis of said dispersion, and
said delay information file includes the corrected design information.

17. A computer readable recorded medium according to claim 15, wherein said logical simulation method further comprises classifying said information on said dispersion into groups of an optional size, said groups constituting said chip, and
said delay information file is prepared so that the influence of said dispersion is considered for every said group.

18. A computer readable recorded medium according to claim 15, wherein said design information includes actual configuration information on the position of a cell of the integrated circuit in an actual configuration, and
said logical simulation method further comprises causing said information on said dispersion to correspond to said actual configuration information to edit said dispersion rule file.

19. A computer readable recorded medium according to claim 15, wherein said electrical and physical characteristics include a power supply voltage, and
said executing of said logical simulation includes verifying whether abnormality is caused in the transmission of said signal by the difference in said power supply voltage in the same chip.

20. A computer readable recorded medium according to claim 16, wherein said electrical and physical characteristics include a power supply voltage, and
said executing of said logical simulation further comprises calculating dispersion of signal level caused by dispersion in said power supply voltage, and a delay time of signal transmission caused by the dispersion of signal level.

21. A computer readable recorded medium according to claim 15, wherein said design information includes information on wiring,
said logical simulation method further comprises dividing said information on wiring into segments corresponding to said size of said group, and
said delay information file is prepared so that the influence of said dispersion is considered for every said segment.
